(19) United States
(12) Patent Application Publication
(10) Pub. No.: US 2014/0311746 A1
(43) Pub. Date: Oct. 23, 2014

(54) USE OF CHELANTS IN FORMATE-BASED SOLUTIONS TO DISSOLVE RESIDUAL FILTERCAKES IN SUBTERRANEAN WELLS

(71) Applicant: M-I L.L.C., Houston, TX (US)

(72) Inventors: Mark Ronald Luyster, Houston, TX (US); Sooi Kim Lim, Houston, TX (US); Clotaire-Marie Eyaa Allogo, Sugar Land, TX (US)

(73) Assignee: M-I L.L.C., Houston, TX (US)

(21) Appl. No.: 14/258,201

(22) Filed: Apr. 22, 2014

Related U.S. Application Data
(60) Provisional application No. 61/814,777, filed on Apr. 22, 2013.

(51) Int. Cl. C09K 8/52; E21B 37/06

(52) U.S. Cl. CPC C09K 8/52; E21B 37/06
USPC 166/312; 507/267

(57) ABSTRACT

A wellbore fluid for dissolving a filtercake includes a chelating agent and an aqueous solution of carboxylate salt. The concentration of the chelating agent is up to 50 percent volume per volume (v/v) in the aqueous solution of carboxylate salt. A method of treating a well includes preparing a wellbore fluid up to 50 percent volume per volume (v/v) chelating agent in an aqueous solution of carboxylate salt. The method further includes emplacing the wellbore fluid downhole such that the wellbore fluid dissolves a filtercake in the well.

### BACKGROUND

This application claims the benefit of U.S. Provisional Application No. 61/814,777 filed on Apr. 22, 2013, the entire disclosure of which is incorporated by reference herein in its entirety.

When drilling or completing wells in earth formations, various fluids are used for a variety of reasons. The fluids are circulated through a drill string and drill bit into a wellbore, and may flow upward through the wellbore to the surface. During this circulation, drilling fluid may cool and lubricate the drill string and bit, remove cuttings from the bottom of the hole to the surface, control subsurface pressures, maintain well stability until the well section is cased and cemented, and isolate fluids within the formation by providing sufficient hydrostatic pressure to prevent the ingress of formation fluids into the wellbore.

Drilling fluids or muds typically include a base fluid (e.g., water, diesel, mineral oil, or synthetic compound) weighting agents (e.g., barium sulfate or barite), bentonite clay, or other viscosifiers to help remove cuttings from the well and form a filtercake on the walls of the hole, lignosulfonates and lignites to keep the mud in a fluid state, and various other additives that serve specific functions.

Forming the filtercake on the surface of the subterranean formation may protect the formation. Filtercakes, consisting mainly of calcium carbonate, form when particles suspended in a wellbore fluid coat and plug the pores in the subterranean formation such that the filtercake prevents or reduces both the loss of fluids into the formation and the influx of fluids present in the formation. A number of ways of forming filtercakes are known in the art, including through the use of bridging particles, cuttings created by the drilling process, polymeric additives, and precipitates.

Upon completion of drilling, the filtercake and/or fluid loss pill may stabilize the wellbore during subsequent completion operations such as placement of a gravel pack in the wellbore. After completion operations have been accomplished, removal of filtercakes may be necessary. Although filtercake formation and use of fluid loss pills are common in the drilling and completion operations, these systems and the barriers they deposit can be a significant impediment to the production of hydrocarbon or other fluids from the well in the event the rock formation is still plugged by the barrier. Because the filtercake is compact, it can adhere strongly to the formation and may not be readily or completely flushed out of the formation by fluid action alone. In addition, this barrier can plug or impede the selected sand control screen or even the gravel pack sand, if used, thus reducing the anticipated production rate and even reduce the ultimate life of the completion.

Efficient well clean-up and completion are significant issues with wells, especially in open-hole horizontal well completions. The productivity of a well may depend on effective and efficient removal of the filtercake while minimizing the potential of water blocking, plugging, or otherwise damaging the natural flow channels of the formation and the completion assembly.

### SUMMARY

In one aspect, a wellbore fluid for dissolving a filtercake is disclosed. The wellbore fluid includes a chelating agent and an aqueous solution of carboxylate salt. The concentration of the chelating agent is up to 50 percent volume per volume (v/v) in the aqueous solution of carboxylate salt.

In another aspect, a method of treating a well is disclosed. The method includes preparing a wellbore fluid up to 50 percent volume per volume (v/v) chelating agent in an aqueous solution of carboxylate salt. The method further includes emplacing the wellbore fluid downhole such that the wellbore fluid dissolves and degrades a filtercake in the well.

In yet another aspect, a method is disclosed. The method includes emplacing a chelating agent in a saturated solution of carboxylate salt into a well, wherein the chelating agent is in an amount of from 41 to 50 percent by weight. The method further includes dissolving a filtercake.

Furthermore, modifications are possible without materially departing from the teachings of the present disclosure. Accordingly, such modifications are intended to be included within the scope of the disclosure as defined in the claims.

### DETAILED DESCRIPTION

Example embodiments are provided so that this disclosure will be thorough, and will fully convey the scope to those who are skilled in the art. Numerous specific details are set forth such as examples of specific components, devices, and method to provide a thorough understanding of embodiments of the present disclosure. It will be apparent to those skilled in the art that specific details need not be employed, that example embodiments may be err bodied in many different forms and that neither should be construed to limit the scope of the disclosure.

Embodiments of the present disclosure relate generally to wellbore fluids that are water-based, and, in particular, are formate-based brines. More specifically, wellbore fluids, according to the present disclosure, may include a formate brine and at least one chelating agent. In some embodiments, wellbore fluids comprising a chelating agent in concentrations up to 50 percent volume per volume (v/v) in the formate brine are shown to effectively dissolve filtercake components (e.g., calcium carbonate). In some aspects, wellbore fluids disclosed herein may dissolve up to about 80% of the calcium carbonate component of filtercakes.

As used herein, brine may refer to various salts and salt mixtures dissolved in an aqueous solution (including any source of aqueous fluid such as fresh water, sea water, or free water). Examples of typical brines include, but are not limited to, formates, acetates, chlorides, bromides, iodides, tungstates, carbonates, bicarbonates, or nitrate salts of ammonium, sodium, potassium, cesium, rubidium, lithium, calcium, magnesium, zinc, or barium, combinations and blends thereof. However, the present disclosure is directed to carboxylate-salt-based brines, including those based on formate salts, acetate salts, citrate salts, and the like. In particular embodiments, the brines of the present disclosure include formate salts of alkali metal cations, including but not limited to. cesium, potassium and/or sodium. In addition to formate salts, brines of the present disclosure may include other carboxylate salts of metal cations, such as cesium, potassium, and or sodium salts of acetate or citrate. Further, in addition to carboxylate salts, such brines may also include halide salts such as bromides or chlorides. For example, a brine may include a mixture of cesium formate and sodium chloride dissolved in an aqueous solution. Thus, there is no limitation on the presence of other salts in the present disclosure.

Brines are used because they are typically, substantially free of suspended solids. Brines enhance the performance of water-based muds (WBMs) by preventing the hydration and migration of swelling clay to reduce formation damage caused by solids or clay swelling or migration. A brine system is typically selected to achieve a suitable and safe working density for use in a particular well-completion operation. One possible advantage of using brines is that for a formation that is found to interact adversely with one type of brine, there is often another type of brine available with which that formation will not interact adversely. Typically, brines are selected from halide salts of mono- or divalent cations, such as sodium, potassium, calcium, and zinc. Chloride-based brines of this type have been used in the petroleum industry for over 50 years and bromide-based brines for at least 25 years. Format-based brines, however, have only been widely used in the industry relatively recently.

Formates, such as cesium formate, may be used as a solids-free base drilling and completion fluid. Cesium formate is the densest of the clear alkali formate fluids, having a specific gravity (s.g.) of 2.3 (density of 19.2 pounds per gallon). Because of this intrinsic high density, the necessity of weighting agents, such as barium sulfate, which can damage tools and the formation, and that are typically used in drilling and completion fluids, include potassium formate and sodium formate. Lower density formate-based brines are often blended with cesium formate brines to produce a fluid between 1.0 and 2.3 s.g., and in some embodiments between 1.57 and 2.3 s.g. Likewise sodium-formate-based brines may be blended with potassium formate brines to produce a fluid between 1.33 and 1.58 s.g. Most often, un-blended sodium-formate-based brines are used to produce fluids below 1.33 s.g.

The formate salts, also referred to herein as carboxylate salts, may be included in the wellbore fluids in an amount enough to achieve compatibility (i.e., no solids or precipitation) after initial mixing and after static aging at room temperature and at 25° F. for 24 hours. In experimental observations, no increase in turbidity was apparent. Furthermore, since pH of the wellbore fluids did not increase after the static aging period, this may be indicative that these species did not sequester any cations to react with the base brines.

In accordance with embodiments of the present disclosure, a chelating agent, also referred to herein as a chelant or chelator, may be added to the formate-based fluid to breakdown components (e.g., gelling structure, calcium carbonate) of a filtercake. Chelating agents useful in the embodiments disclosed herein may be a polydentate chelator such that multiple bonds are formed with the complexed metal ion. Molecules of ethylenediaminetetraacetic acid (EDTA) and N-(2-Hydroxyethyl)ethylenediamine-N,N′,N′-triacetic acid (HEDTA), as mere examples of suitable chelating agents, may have numerous protons on the carboxylate groups. The protons may destroy components of the filtercake, such as polymer/starch and gelling structure, and expose calcium carbonate to react with the chelating agents. Enhanced ability to destroy the calcium carbonate component of filtercakes may be a product of carboxylate ion groups of EDTA and/or HEDTA having abilities to sequester calcium ions by forming complex bonds.

Suitable chelators may include, for example, EDTA, HEDTA, diethylenetriaminepentaacetic acid (DTPA), nitrilotriacetic acid (NTA), ethylene flycol-bis(2-aminoethyl)-N,N,N′,N′-tetraaceticacid (BAPTA), cyclohexanediaminetetraccetic acid (CDTA), triethylenetetraaminehexaacetic acid (TTHA), glutamic-N,N-diacetic acid (GLDA), ethylene-diamine tetra-methylene sulfonic acid (EDTMS), diethylene-triamine penta-methylene sulfonic acid (DETPMS), amino tri-methylene sulfonic acid (ATMS), ethylene-diamine tetramethylene phosphonic acid (EDTMP), diethylene-triamine penta-methylene phosphonic acid (DETPMP), amino tri-methylene phosphonic acid (ATMP), salts thereof, and mixtures thereof. However, the above list is not intended to have any limitation on the chelating agents suitable for use in the embodiments disclosed herein. One of ordinary skill in the art would recognize that selection of the chelating agent may depend on the metal ions likely present downhole. In particular, the selection of the chelating agent may be related to the specificity of the chelating agent to the particular cations, the logK value, the optimum pH for sequestering and the commercial availability of the chelating agent, as well as downhole conditions.

In one embodiment, concentrations of chelating agents, such as HEDTA and EDTA, may be up to 50% volume per volume (v/v) in an aqueous solution of carboxylate salt. In other embodiments, concentrations of chelating agents, such as HEDTA and EDTA, may range from 20% to 50% v/v. In yet other embodiments, concentrations of chelating agents may range from 50% to 80% v/v. Thus, as defined, the volume-to-volume ratio represents the volume (e.g., liter) of salt in liters of solution, and may include salt that may be either dissolved or suspended in the solution at room temperature, inasmuch as the suspended salt may become soluble at a higher temperature. However, one skilled in the art would appreciate that the amount may vary depending on the density of the wellbore fluid desired for a particular application.

In another embodiment, chelating agents, such as HEDTA and EDTA, are utilized in near saturated formate brines, i.e., 13.1 lb/gal potassium formate and 19.2 lb/gas cesium formate solutions. In another embodiment, the chelating agent is in an amount from 41% to 50% by weight. In yet another embodiment, the chelating agent is in an amount from 50% to 80% by weight.

### EXAMPLE 1

Samples were mixed as reported in the Table 1 below. The target volume for each sample approximated 100 mLs. Each sample was aliquoted for static aging. One set of samples was statically aged at room temperature a id the second was statically aged at 25° F. The initial pH was recorded immediately after mixing. The pH of the aged samples was recorded and compared. Digital images were recorded initially and after aging at 25° F. The static aging at 25° F. was performed as the thermal dynamics at this temperature would more readily promote precipitation versus room or any elevated temperature.

### EXAMPLE 2

As seen in these laboratory trials of breaker systems, static aged blends of cesium formate and HEDTA after 24 hrs at 25° F. showed no precipitates or apparent solids. Similarly, static aged blends of cesium formate and EDTA after 24 hrs at 25° F. also showed no precipitates or apparent solids. Static aged blends of potassium formate and HEDTA after 24 hrs at 25° F. showed no precipitates or apparent solids. Likewise, static aged blends of potassium formate and EDTA after 24 hrs at 25° F. showed no precipitates or apparent solids. Thus, compatibility was seen for all formulations below.

TABLE 1
Summary of Formulations and Results

| Formulations | | | | | | | |
|---|---|---|---|---|---|---|---|
| | | HEDTA | EDTA | Results | | | |
| K formate | Cs formate | (1.21 | (1.26 | Density | Density | pH | pH |
| (1.57 s.g.) | (2.3 s.g.) | s.g.) | s.g.) | SG | ppg | initial | after 24 hrs |
| 65 | | 35 | | 1.44 | 12.03 | 7.04 | 7.15 |
| 60 | | 40 | | 1.43 | 11.88 | 6.92 | 7.02 |
| 55 | | 45 | | 1.41 | 11.73 | 6.90 | 6.96 |
| 50 | | 50 | | 1.39 | 11.58 | 6.83 | 6.84 |
| 65 | | | 35 | 1.46 | 12.18 | 8.67 | 8.70 |
| 60 | | | 40 | 1.45 | 12.05 | 8.65 | 8.68 |
| 55 | | | 45 | 1.43 | 11.92 | 8.60 | 8.66 |
| 50 | | | 50 | 1.42 | 11.79 | 8.57 | 8.63 |
| | 65 | 35 | | 1.92 | 15.99 | 7.03 | 7.02 |
| | 60 | 40 | | 1.86 | 15.53 | 6.96 | 6.93 |
| | 55 | 45 | | 1.81 | 15.08 | 6.80 | 6.90 |
| | 50 | 50 | | 1.76 | 14.63 | 6.75 | 6.80 |
| | 55 | | 45 | 1.83 | 15.27 | 8.56 | 8.45 |
| | 50 | | 50 | 1.78 | 14.83 | 8.60 | 8.50 |

### EXAMPLE 3

This example illustrates, among other things, EDTA and HEDTA chelating agents and apparent effects on filtercake (i.e., calcium carbonate) dissolution: The breaker components below were evaluated at room temperature and at 25° F.

Breaker 1 Sample—12.17 ppg breaker using HEDTA in 13.08 ppg potassium formate, as a brine to build density, exhibited a relatively high return flow and high calcium carbonate dissolution. Experimental data revealed of return of initial flow after three days of static aging with this breaker system. Further, 81% of calcium carbonate dissolved after less than an 8 hour static aging at 150° F. with 5 g of calcium carbonate 2 μm.

Breaker 2 Sample—13.17 ppg breaker using EDTA in 13.08 ppg potassium formate and 19.16 ppg cesium formate exhibited a relatively low return flow and low calcium carbonate dissolution. Experimental data revealed 90% of return of initial flow. Further, 25% of calcium carbonate dissolved after less than an 8 hour static soak at 150° F. with 5 g of calcium carbonate 2 μm. Results indicated less than 25% of filtercake and gel structure remaining on the aloxite disk.

Breaker 3 Sample—13.08 ppg breaker using EDTA in 19.16 ppg cesium formate and fresh water exhibited a high return flow and low calcium carbonate dissolution. Experimental data revealed 97% of return of initial flow. Further, 31% of calcium carbonate dissolved after less than an 8 hour static soak at 150° F. with 5 g of calcium carbonate 2 μm. Results indicated less than 25% of the filtercake and less than 15% of gel structure remaining on the aloxite disk.

Breaker 4 Sample—12.66 ppg breaker using EDTA in potassium formate and wellzyme A exhibited a relatively low return of initial flow. Experimental data revealed 78% of return. Results indicated filtercake with less visual gel structure remaining on the aloxite disk.

Breaker 5 Sample—12.41 ppg breaker using EDTA in potassium formate, fresh water, and Wellzyme A exhibited a relatively a high return flow. Experimental data revealed 98% of return of initial flow. Results indicated remaining peeled off when water was decanted.

Breaker 6 Sample—13.10 ppg breaker EDTA in cesium formate exhibited a relatively high return flow and low calcium carbonate dissolution. Experimental data revealed 97% of return of initial flow. Results indicated less than 50% of filtercake remaining on the aloxite disk.

Wellbore fluids of embodiments of this disclosure containing chelating agents may be emplaced in the wellbore using conventional techniques known in the art, and may be used in drilling, completion, workover operations, etc. Additionally, one skilled in the art would recognize that such wellbore fluids may be prepared with a large variety of formulations. Specific formulations may depend on the stage in which the fluid is being used, for example, depending on the depth and/or the composition of the formation. The wellbore fluids described above may be adapted to provide improved completion fluids under conditions of high temperature and pressure, such as those encountered in deep wells. Further, one skill in the art would recognize that other additives may be included in the drilling fluid disclosed herein, for instance, weighting agent, wetting agents, viscosifiers, surfactants, dispersants, interfacial tension reducers, pH buffers, mutual solvents, thinners, and thinning agents.

Embodiments of the present disclosure may provide for wellbore fluids to effectively dissolve filtercakes at relatively higher density. The incorporation of a chelating agent in the wellbore fluids of the present disclosure may allow for the availability of protons to degrade components of the filtercake and expose the calcium carbonate of such filtercakes to react with the chelating agents. Further, the carboxylate groups of the chelating agents form complex bonds with sequestered calcium ions, thus further enabling the degradation of the calcium carbonate component in filtercakes. Compositions and methods to effectively degrade filtercakes disclosed herein may be employed to enhance the long-term productivity of a well.

The foregoing description of the embodiments has been provided for purposes of illustration and description. Although the preceding description has been described herein with reference to particular means, materials, and embodiments, it is not intended to be limited to the particulars disclosed herein; rather, it extends to all functionally equivalent structures, methods, and uses, such as are within the scope of the appended claims.

What is claimed is:

1. A wellbore fluid for dissolving a filtercake, the fluid comprising:
a chelating agent; and
an aqueous solution of carboxylate salt, wherein concentration of the chelating agent is up to 50 percent volume per volume (v/v) in the aqueous solution of carboxylate salt.

2. The fluid of claim 1, wherein the chelating agent is in an amount from 41 to 50 percent by weight.

3. The fluid of claim 1, wherein the carboxylate salt comprises at least one of a cesium formate, a potassium formate, and a sodium formate.

4. The fluid of claim 3, wherein the potassium formate has a specific gravity of about 1.57.

5. The fluid of claim 3, wherein the cesium formate has a specific gravity of about 2.3.

6. The fluid of claim 1, wherein the chelating agent includes at least one of EDTA, GLDA, HEDTA, DTPA, NTA, BAPTA, CDTA, and TTHA.

7. The fluid of claim 1, wherein the chelating agent is from 50 to 80 percent volume per volume (v/v) in the aqueous solution of carboxylate salt.

8. A method of treating a well, the method comprising:
preparing a wellbore fluid up to 50 percent volume per volume (v/v) chelating agent in an aqueous solution of carboxylate salt; and
emplacing the wellbore fluid downhole such that the wellbore fluid dissolves a filtercake in the well.

9. The method of claim 8, wherein the chelating agent is in an amount from 41 to 50 percent by weight.

10. The method of claim 8, wherein pH of the wellbore fluid is from about 6.8 to 8.7.

11. The method of claim 8, wherein the carboxylate salt comprises at least one of a cesium formate, a potassium formate, and a sodium formate.

12. The method of claim 8, wherein the chelating agent includes at least one of EDTA, GLDA, HEDTA, DTPA, NTA, BAPTA, CDTA, and TTHA.

13. The method of claim 8, wherein the filtercake comprises calcium carbonate.

14. The method of claim 18, wherein he calcium carbonate dissolves by about 80%.

15. A method comprising:
emplacing a chelating agent in a saturated solution of carboxylate salt into a well, wherein the chelating agent is in an amount of from 41 to 50 percent by weight; and
dissolving a filtercake.

16. The method of claim 15, wherein the chelating agent is up to 50 percent volume per volume (v/v) in the saturated solution of carboxylate salt.

17. The method of claim 15, wherein the carboxylate salt comprise at least one of a cesium formate, a potassium formate, and a sodium formate.

18. The method of claim 15, wherein the chelating agent includes at least one of EDTA, GLDA, HEDTA, DTPA, NTA, BAPTA, CDTA, and TTHA.

19. The method of claim 15, wherein the filtercake comprises calcium carbonate.

20. The method of claim 19, further comprising:
dissolving about 80% of the calcium carbonate.
